(19) United States
(12) Patent Application Publication
(10) Pub. No.: US 2025/0365631 A1
(43) Pub. Date: Nov. 27, 2025

(54) USER EQUIPMENT IDENTIFICATION DURING A LOWER-LAYER TRIGGERED MOBILITY SESSION

(71) Applicant: QUALCOMM Incorporated, San Diego, CA (US)

(72) Inventors: Naeem AKL, Bridgewater, NJ (US); Jelena DAMNJANOVIC, Del Mar, CA (US); Shankar KRISHNAN, Poway, CA (US); Ozcan OZTURK, San Diego, CA (US)

(21) Appl. No.: 18/674,547

(22) Filed: May 24, 2024

(51) Int. Cl. H04W 36/32; H04W 36/00

(52) U.S. Cl. CPC H04W 36/324; H04W 36/0016

(57) ABSTRACT

Methods, systems, and devices for wireless communications are described. A first network entity communicates, with a third network entity, a first message indicating an identifier (ID) associated with a lower-layer triggered mobility (LTM) procedure for a user equipment (UE), the ID for indicating that the UE is associated with the LTM procedure between the first network entity and a second network entity. The first network entity transmits, to the UE, a second message indicating to perform a cell switch operation from communications with the first network entity to the second network entity or the third network entity in accordance with the LTM procedure.

### FIELD OF TECHNOLOGY

The present disclosure relates to wireless communications, including user equipment identification during a lower-layer triggered mobility session.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, an ongoing communication session of a user equipment (UE) with one cell may be transferred to another cell as part of a handover (e.g., mobility) process of a lower-layer triggered mobility (LTM) procedure. Conventional LTM techniques can be improved.

### SUMMARY

The systems, methods, and devices of this disclosure each have several innovative aspects, no single one of which is solely responsible for the desirable attributes disclosed herein.

To identify a user equipment (UE) in a handover procedure with multiple candidate network entities in a cell of the handover procedure, the first network entity (e.g., serving network entity) may forward a UE ID allocated by the second network entity (e.g., candidate network entity) to the third network entity (e.g., candidate network entity) along with an indication of the second network entity. The third network entity may include the ID in signaling towards the second network entity. In some examples, the first network entity may allocate a UE ID and forward it to both the second and third network entities. The third network entity may include the ID along with an indication of the first network entity into signaling towards the second network entity. In some examples, the first network entity may forward an lower-layer triggered mobility (LTM) procedure session ID associated with the UE to both the second and third network entities. In some examples, the first network entity may forward an temporary mobile subscriber identity (TMSI) session ID associated with the UE to both the second and third network entities. In some examples, the first network entity may operate as a proxy between the second and third network entities, such that the first network entity forwards UE-associated messages to the other candidate network entity.

A method for wireless communications by a first network entity is described. The method may include communicating, with a third network entity, a first message indicating an identifier associated with an LTM procedure for a UE, the identifier for indicating that the UE is associated with the LTM procedure configured between the first network entity and a second network entity and transmitting, to the UE, a second message indicating to perform a cell switch operation from communications with the first network entity to the second network entity or the third network entity in accordance with the LTM procedure.

A first network entity for wireless communications is described. The first network entity may include one or more memories storing processor executable code, and one or more processors coupled with the one or more memories. The one or more processors may individually or collectively be operable to execute the code to cause the first network entity to communicate, with a third network entity, a first message indicating an identifier associated with a LTM procedure for a UE, the identifier for indicating that the UE is associated with the LTM procedure configured between the first network entity and a second network entity and transmit, to the UE, a second message indicating to perform a cell switch operation from communications with the first network entity to the second network entity or the third network entity in accordance with the LTM procedure.

Another first network entity for wireless communications is described. The first network entity may include means for communicating, with a third network entity, a first message indicating an identifier associated with an LTM procedure for a UE, the identifier for indicating that the UE is associated with the LTM procedure configured between the first network entity and a second network entity and means for transmitting, to the UE, a second message indicating to perform a cell switch operation from communications with the first network entity to the second network entity or the third network entity in accordance with the LTM procedure.

A non-transitory computer-readable medium storing code for wireless communications is described. The code may include instructions executable by one or more processors to communicate, with a third network entity, a first message indicating an identifier associated with an LTM procedure for a UE, the identifier for indicating that the UE is associated with the LTM procedure configured between the first network entity and a second network entity and transmit, to the UE, a second message indicating to perform a cell switch operation from communications with the first network entity to the second network entity or the third network entity in accordance with the LTM procedure.

In some examples of the method, first network entities, and non-transitory computer-readable medium described herein, the identifier includes a UE identifier allocated by the second network entity.

In some examples of the method, first network entities, and non-transitory computer-readable medium described herein, the UE identifier includes a backhaul application protocol identifier.

In some examples of the method, first network entities, and non-transitory computer-readable medium described herein, the identifier includes a UE identifier allocated by the first network entity and the method, apparatuses, and non-transitory computer-readable medium may include further operations, features, means, or instructions for communicating, to the second network entity and the third network entity, the UE identifier allocated by the first network entity.

Some examples of the method, first network entities, and non-transitory computer-readable medium described herein may further include operations, features, means, or instructions for transmitting, to the second network entity, a third message indicating that the third network entity will communicate with the second network entity.

In some examples of the method, first network entities, and non-transitory computer-readable medium described herein, the identifier includes an LTM session identifier, the LTM session identifier indicating a serving network entity during an LTM preparation procedure of the LTM procedure.

In some examples of the method, first network entities, and non-transitory computer-readable medium described herein, the identifier includes an LTM identifier coordinated between the first network entity as a serving network entity during an LTM preparation procedure of the LTM procedure and the second network entity, the third network entity, or any combination thereof, as target network entities.

In some examples of the method, first network entities, and non-transitory computer-readable medium described herein, the identifier includes an indication of an access and mobility management function associated with the UE.

In some examples of the method, first network entities, and non-transitory computer-readable medium described herein, the identifier includes a TMSI provided by the UE to the first network entity.

In some examples of the method, first network entities, and non-transitory computer-readable medium described herein, the identifier includes a TMSI provided by an access and mobility management function associated with the UE to the first network entity during an LTM preparation procedure.

In some examples of the method, first network entities, and non-transitory computer-readable medium described herein, the first network entity serves as a proxy between the second network entity and the third network entity.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports user equipment identification during a lower-layer triggered mobility session in accordance with one or more aspects of the present disclosure.

FIG. 2 shows an example of a wireless communications system that supports user equipment identification during a lower-layer triggered mobility session in accordance with one or more aspects of the present disclosure.

FIG. 3 shows an example of a process flow that supports user equipment identification during a lower-layer triggered mobility session in accordance with one or more aspects of the present disclosure.

FIG. 4 shows an example of a process flow that supports user equipment identification during a lower-layer triggered mobility session in accordance with one or more aspects of the present disclosure.

FIG. 5 shows an example of a process flow that supports user equipment identification during a lower-layer triggered mobility session in accordance with one or more aspects of the present disclosure.

FIG. 6 shows an example of a process flow that supports user equipment identification during a lower-layer triggered mobility session in accordance with one or more aspects of the present disclosure.

FIG. 7 shows an example of a process flow that supports user equipment identification during a lower-layer triggered mobility session in accordance with one or more aspects of the present disclosure.

FIG. 8 shows an example of a process flow that supports user equipment identification during a lower-layer triggered mobility session in accordance with one or more aspects of the present disclosure.

FIGS. 9 and 10 show block diagrams of devices that support user equipment identification during a lower-layer triggered mobility session in accordance with one or more aspects of the present disclosure.

FIG. 11 shows a block diagram of a communications manager that supports user equipment identification during a lower-layer triggered mobility session in accordance with one or more aspects of the present disclosure.

FIG. 12 shows a diagram of a system including a device that supports user equipment identification during a lower-layer triggered mobility session in accordance with one or more aspects of the present disclosure.

FIGS. 13 and 14 show flowcharts illustrating methods that support user equipment identification during a lower-layer triggered mobility session in accordance with one or more aspects of the present disclosure.

### DETAILED DESCRIPTION

In some wireless communications systems, an ongoing communication session of a user equipment (UE) with one cell may be transferred to another cell as part of a handover (e.g., mobility) process of a lower-layer triggered mobility (LTM) procedure. To reduce communication interruptions and to reduce multiple random access-channel (RACH) procedures that may be associated with transitioning between cells, the UE may be configured with multiple configurations corresponding to each of the multiple candidate cells. However, in some cases, the handover cell may include multiple network entities that may function as a candidate network entity for the transferred communications with the UE. For example, the UE may be configured with a first configuration to communicate with a first network entity of a first cell, a second configuration to communicate with a second network entity of a second cell, and a third configuration to communicate with a third network entity of the second cell. During the LTM procedure (e.g., during a preparation process), the first network entity and the second network entity may communicate an identifier (ID) to identify the UE and the first network entity and the third entity may communicate another ID to identify the UE. However, the second network entity and the third network entity may not have knowledge of the respective IDs that were communicated to the first network entity.

In such examples, the multiple candidate network entities (e.g., the second network entity and/or the third network entity) may be unable to identify the same UE as a handover UE during a handover procedure. For example, to transition communications to a candidate network entity, the candidate network entity may identify the UE as a UE that has been configured with a configuration to communicate with the candidate network entity. Accordingly, transitioning communication between cells with multiple candidate network entities in a cell in a handover procedure may be difficult or inefficient without the candidate network entities being able to identify the particular UE.

To identify the UE in a handover procedure with multiple candidate network entities in a cell of the handover procedure, the first network entity (e.g., serving network entity) may forward the UE ID allocated by the second network entity (e.g., candidate network entity) to the third network entity (e.g., candidate network entity) along with an indication of the second network entity. The third network entity may include the ID in signaling towards the second network entity.

In some examples, the first network entity may allocate a UE ID and forward the UE ID to both the second and third network entities. The third network entity may include the ID along with an indication of the first network entity into signaling towards the second network entity. In some examples, the first network entity may forward an LTM session ID associated with the UE to both the second and third network entities. In some examples, the first network entity may forward an temporary mobile subscriber identity (TMSI) session ID associated with the UE to both the second and third network entities. In some examples, the first network entity may operate as a proxy between the second and third network entities, such that the first network entity forwards UE-associated messages to the other candidate network entity.

Aspects of the disclosure are initially described in the context of wireless communications systems. Aspects of the disclosure are further illustrated by and described with reference to apparatus diagrams, system diagrams, and flowcharts that relate to UE identification during a LTM session.

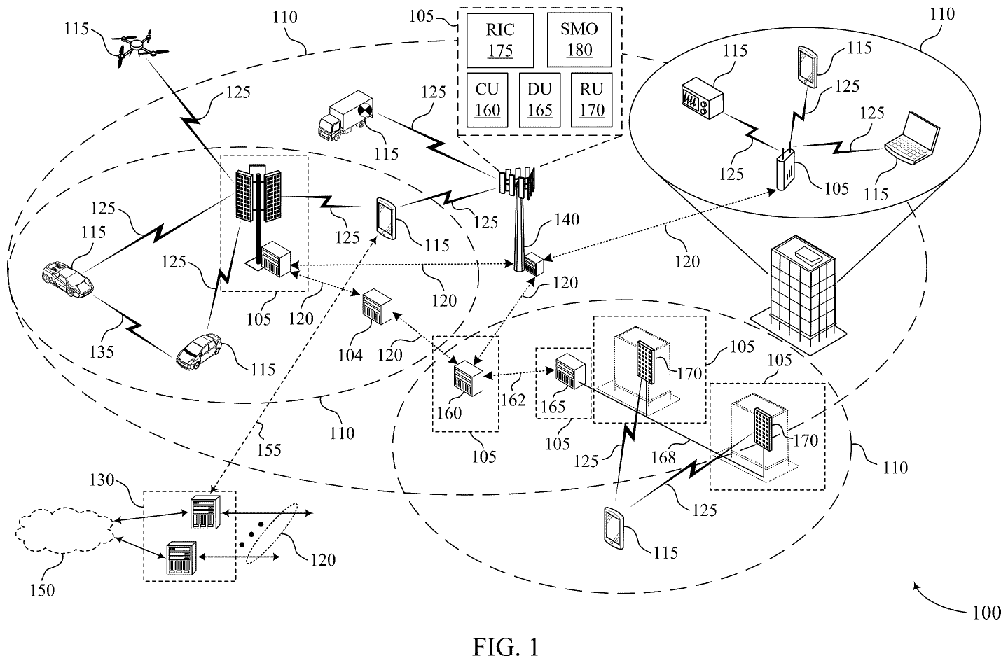

FIG. 1 shows an example of a wireless communications system 100 that supports UE identification during a LTM session in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1, 4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples. Devices in wireless communications system 100 may communicate over unlicensed spectrum, such as the 5 GHz band, the 2.4 GHz band, the 60 GHz band, the 3.6 GHz band, and/or the 900 MHz band. The unlicensed spectrum may also include other frequency bands.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, the wireless communications systems 100 may include an ongoing communication session of the UE 115 with one cell that may be transferred to another cell as part of an LTM handover. To reduce communication interruptions and to reduce multiple RACH procedures that may otherwise be associated with transitioning between cells and/or network entities 105 of the cells, the UE 115 may be configured with multiple configurations corresponding to each of the multiple candidate cells. However, in some cases, handover candidate cells may include multiple candidate network entities 105 for the transferred communications with the UE 115. For example, the UE 115 may be configured with a first configuration to communicate with a first network entity 105 of a first cell, a second configuration to communicate with a second network entity 105 of a second cell, and a third configuration to communicate with a third network entity of a third cell. During the LTM procedure (e.g., during a preparation process), the first network entity and the second network entity may communicate an ID to identify the UE 115 and the first network entity 105 and the third network entity 105 may communicate another ID to identify the UE 115. However, the second network entity 105 and the third network entity 105 may not have knowledge of the respective IDs that were communicated to the first network entity 105 of the first cell.

In such examples, the multiple candidate network entities 105 (e.g., the second network entity and/or the third network entity) may be unable to identify the same UE 115 as a handover UE 115 during a handover procedure. For example, to transition communications to a candidate network entity 105, the candidate network entity 105 may identify the UE 115 as a UE 115 that has been configured with a configuration to communicate with the candidate network entity 105. Accordingly, transitioning communication between multiple candidate network entities 105 in multiple cells in a handover procedure may be difficult or inefficient without the candidate network entities 105 being able to identify the particular UE 115.

To identify the UE 115 in a handover procedure with multiple candidate network entities 105 of the handover procedure, the first network entity 105 (e.g., serving network entity) may forward the UE ID allocated by the second network entity 105 (e.g., candidate network entity) to the third network entity 105 (e.g., candidate network entity) along with an indication of the second network entity 105. The third network entity 105 may include the ID in signaling towards the second network entity 105.

In some examples, the first network entity 105 may allocate a UE ID and forward the UE ID to both the second and third network entities 105. The third network entity 105 may include the ID along with an indication of the first network entity 105 into signaling towards the second network entity 105. In some examples, the first network entity 105 may forward an LTM session ID associated with the UE 115 to both the second and third network entities 105. In some examples, the first network entity 105 may forward an TMSI session ID associated with the UE 115 to both the second and third network entities 105. In some examples, the first network entity 105 may operate as a proxy between the second and third network entities 105, such that the first network entity 105 forwards UE-associated messages to the other candidate network entity 105. The techniques discussed herein may reduce communication interruptions and RACH procedures that may otherwise be associated with transitioning between cells and/or network entities 105 during a handover procedure.

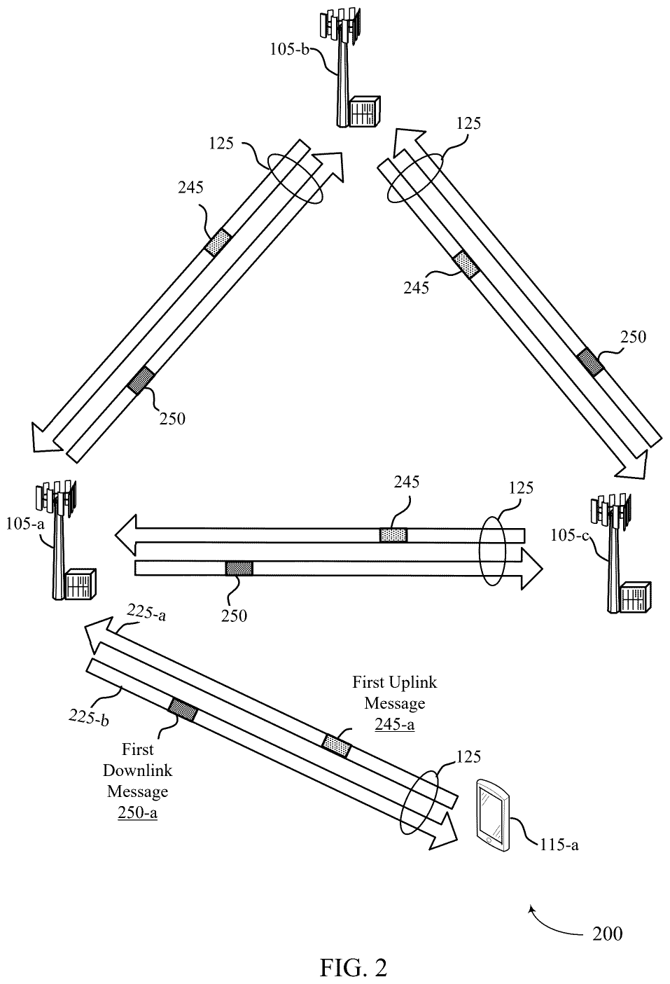

FIG. 2 shows an example of a wireless communications system 200 that supports UE identification during a LTM session in accordance with one or more aspects of the present disclosure. The wireless communications system 200 may implement aspects of or may be implemented by aspects of the wireless communications system 100. For example, the wireless communications system 200 includes a UE 115-a and a network entity 105-a, which may be examples of a UE 115 and a network entity 105 described with respect to FIG. 1. The wireless communications system 200 also includes a network entity 105-b and a network entity 105-c that may be examples of a network entity 105 described with respect to FIG. 1.

In some examples, the LTM handover procedure performed in the wireless communications system 200 may include the UE 115-a communicating with the network entity 115, which may be the serving network entity prior to a handoff to either the network entity 105-b or network entity 105-c. For example, an LTM session, which may be part of the handover procedure, may include multiple phases, such as LTM preparation, early synchronization, LTM cell switch execution, and LTM cell switch completion. During the LTM preparation, the UE 115-a may be connected to the network entity 105-a (e.g., an RRC connected mode, RRC connection is established), the UE 115-a may provide a measurement report to the network entity 105-a. Based on the measurement report, the network entity 105-a may prepare LTM candidates. The network entity 105-a may communicate an RRC reconfiguration to the UE 115-a based on the LTM candidate preparation (e.g., configurations associated with the candidate second network entity 105-b and/or network entity 105-c ). The UE 115-a may transmit signaling to the network entity 105-a that indicates that the reconfiguration is completed.

During the early synchronization, the network entity 105-a may perform downlink synchronization with the candidate cells and the UE 115-a may perform uplink synchronization with the candidate cells. Next, during the LTM cell switch execution, the UE 115-a may transmit a layer 1 (L1) measurement report so that the network entity 105-a may make an LTM decision based on the indicated measurements. The network entity 105-a may communicate signaling indicating a cell switch command (e.g., via medium access control element (MAC-CE)) to the UE 115-a. Accordingly, the UE 115-a may detach from the source, which is the serving first network entity 105-a, and apply target configurations based on the candidate cell indicated in the cell switch command. The UE 115-a may perform a RACH procedure based on the target cell if a TA is not available. During the LTM cell switch completion, the UE 115-a may indicate presence (e.g., communication with new cell) and determines successful completion. However, in some examples, there may be multiple network entity entities 105 that are handover candidate network entities, such as the network entity 105-b and/or the network entity 105-c of the same or different cells.

In such examples, the LTM session may include a cell switch between L1 and layer 2 (L2) mobility candidate network entity entities 105 without RRC reconfiguration. As discussed herein, sequential L1/L2 cell changes between candidate network entities 105 without RRC reconfiguration may be supported and may provide various mobility enhancements. For example, the techniques describe ed herein may support inter-CU L2 mobility (e.g., LTM, such as for RAN layer 2 (RAN2) and/or RAN layer 3 (RAN3)), prioritizing when CU is functioning as an master node (MN) when dual connectivity (DC) is not configured, NR-DC is configured and CU functioning as a secondary node (SN) and master cell group (MCG) is unchanged, NR-DC is configured and CU is acting as an MN and secondary cell group (SCG) is unchanged or SCG is released, and/or coordination with SA3 with respect to security key handling.

The techniques discussed herein may be applied to the network entity 105 and/or the UE 115-a after a cell switch in the LTM procedure (e.g., subsequent LTM). In some examples, Xn Application Protocol (XnAP) UE IDs may be linked to lower-layer UE IDs (e.g., cell radio network temporary identifier (C-RNTI)) at the time the XnAP IDs are instantiated. Accordingly, the candidate network entities 105 may easily link an Xn UE context to the physical UE 115-a. In some examples, such as when more than two candidate network entities 105 are available for the LTM handover procedure, instantiation of XnAP UE IDs among selected pairs of network entities 105 may be difficult to link to the physical UE 115-a. The lack of linking the XnAP UE Ids to the particular UE 115-a may result in a bootstrapping issue for the XnAP UE-associated signaling.

In some examples, the issue of linking IDs to the UE 115-a may occur when the first network entity 105-a (serving network entity) and the second network entity 105-b (e.g., candidate network entity) instantiate (first network entity UE XnAP ID, second network entity UE XnAP ID) for the UE 115-a during the LTM preparation initiated by the first network entity 105-a. The first network entity 105-a and the third network entity 105-c may also instantiate (first network entity UE XnAP ID, third network entity UE XnAP ID) for the UE 115-a during the LTM preparation initiated by the first network entity 105-a. After the LTM execution, any XnAP signaling associated with the UE 115-a may involve reusing the ID(s) instantiated during LTM preparation. However, the second network entity 105-b and the third network entity 105-c may be unaware which ID properly identifies the physical UE when the second network entity 105-b and the third network entity 105-c want to exchange XnAP signaling associated with the UE 115-a.

During LTM preparation, the UE-associated Xn signaling may be exchanged between the serving first network entity 105-a and each of the candidate second network entity 105-b and the third network entity 105-c . The UE-associated Xn signaling from the first network entity 105-a may instantiate UE ID(s) that may be reused by the second network entity 105-b and the third network entity 105-c in the future (e.g., after LTM execution) to exchange UE-associated Xn messaging. However, in some examples, during LTM preparation, no UE-associated Xn signaling is exchanged among the candidate second network entity 105-b and the third network entity 105-c. Therefore, there is no shared common understanding of UE identification (e.g., UE ID) that may be used by the candidate second network entity 105-b and the third network entity 105-c in the future (e.g., after LTM execution) to exchange UE-associated Xn messaging.

In the wireless communications system 200, the network entities 105 may communicate one or more IDs between the first network entity 105-a, the second network entity 105-b , and/or the third network entity 105-c , as discussed herein, to facilitate identifying the physical UE 115-a as associated with a particular ID. The network entity 105-a may communicate with the UE 115-a (e.g., when the first network entity 105-a is the serving network entity 105) using a communication link 125. In some examples, the communication link 125 may include a first channel 225-a for transmitting data from the UE 115-a to the network entity 105-a and a second channel 225-b for transmitting data from the network entity 105-a to the UE 115-a. The communication link 125 may be an example of an NR or LTE link between the UE 115-a and the network entity 105-a. The communication link 125 may include a bi-directional link that enables both uplink and downlink communications, for example, via the channels 225. For example, the UE 115-a may transmit uplink messages 245 (e.g., uplink transmissions), such as uplink control signals or uplink data signals, to the network entity 105-a using the first channel 225-a (e.g., of the communication link 125) and the network entity 105-a may transmit downlink messages 250 (e.g., downlink transmissions), such as downlink control signals or downlink data signals, to the UE 115-a using the second channel 225-b (e.g., of the communication link 125). In some examples, the downlink messages 250 may be part of control signaling transmitted from the network entity 105-a.

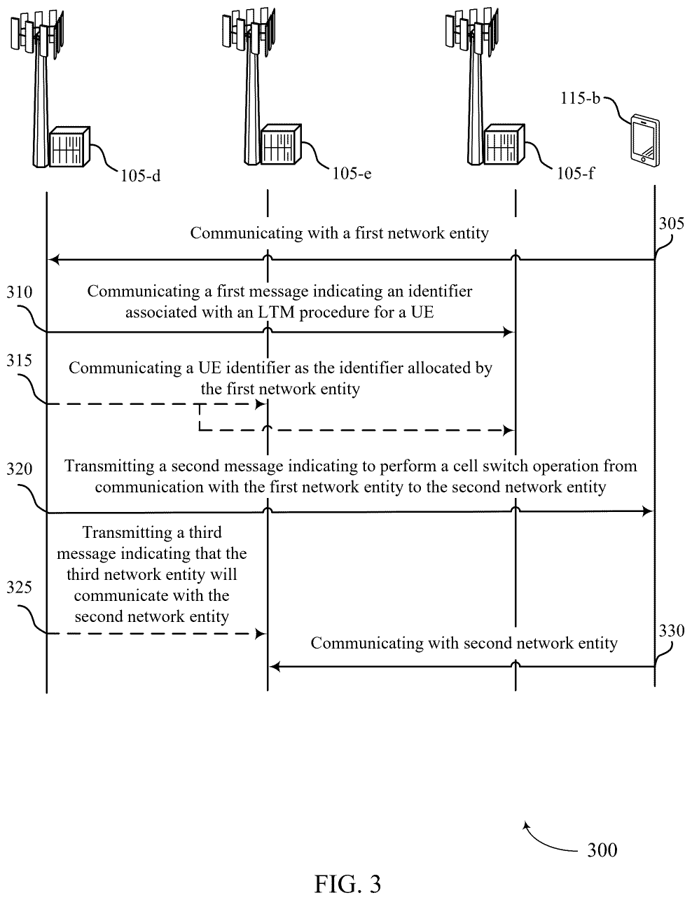

For example, the UE 115-a may transmit a first uplink message 245-a to the network entity 105-a, where the first uplink message 245-a may include a measurement report as discussed herein. The network entity 105-a may transmit a first downlink message 250-a, which may include a message indicating one or more cell and/or network entity configurations for the UE 115-a to participate in the handover procedure to a candidate network entity 105. As discussed with respect to FIG. 3, signaling indicating UE IDs may be communicated between the first network entity 105-a, the second network entity 105-b and/or the third network entity 105-c , and the signaling may be communicated via respective communication links 125 between the network entities 105, which may be used to communicate uplink messages 245 and downlink messages 250.

FIG. 3 shows an example of a process flow 300 that supports UE identification during a LTM session in accordance with one or more aspects of the present disclosure. The process flow 300 may implement aspects of or may be implemented by aspects of the wireless communications system 100 or the wireless communications system 200. For example, the process flow 300 may include a UE 115-b and a network entity 105-d, a network entity 105-e, and a network entity 105-f, which may be an example of a UE 115 and a network entity 105 as described herein. In the following description of the process flow 300, the operations performed by the UE 115-b and the network entities 105 may be performed in different orders or at different times than the exemplary order shown. Some operations may also be omitted from the process flow 300, or other operations may be added to the process flow 300. Further, while operations in the process flow 300 are illustrated as being performed by the UE 115-b and the network entities 105, the examples herein are not to be construed as limiting, as the described features may be associated with any quantity of different device. As discussed herein, the first network entity 105-d may be the serving network entity, the second network entity 105-e and the third network entity 105-f may be the candidate network entities 105.

At 305, the UE 115-b may initially communicate with the first network entity 105-d, which may be the serving network entity 105. The LTM procedure may involve transferring the ongoing communication between the first network entity 105-d to a candidate network entity 105, and there may be multiple candidates, such as the second network entity 105-e and the third network entity 105-f. In some examples, each of the network entity 105 may be associated with respective cells. At 310, a first network entity 105-d (e.g., serving network entity 105) may communicate, with a third network entity 105-f, a first message indicating an ID associated with a LTM procedure for a UE 115-b, the ID for indicating that the UE 115-b is associated with the LTM procedure configured between the first network entity 105-d and a second network entity 105-e. In some examples, the ID may include a UE ID allocated by the second network entity 105-e. In such examples, the UE ID may include a backhaul application protocol identifier (API).

In some examples, where the ID includes a UE ID allocated by the first network entity 105-d, at 315, the first network entity 105-d may communicate, to the second network entity 105-e and the third network entity 105-f, the UE ID as the ID allocated by the first network entity 105-d.

At 320, the first network entity 105-d may transmit, to the UE 115-b, a second message indicating to perform a cell switch operation from communications with the first network entity 105-d to the second network entity 105-e or the third network entity 105-f in accordance with the LTM procedure.

In some examples, where the ID includes a UE identifier allocated by the first network entity 105-d, the first network entity 105-d may communicate, to the second network entity 105-e and the third network entity 105-f, the UE ID allocated by the first network entity 105-d. In such examples, at 325, the first network entity 105-d may transmit, to the second network entity 105-e, a third message indicating that the third network entity 105-f will communicate with the second network entity 105-e. In this manner, the second network entity 105-e and the third network entity 105-f may anticipate the communication between the second network entity 105-e and the third network entity 105-f, and that the second network entity 105-e and the third network entity 105-f may identify a UE 115 (e.g., same UE is identified by the second network entity 105-e and the third network entity 105-f).

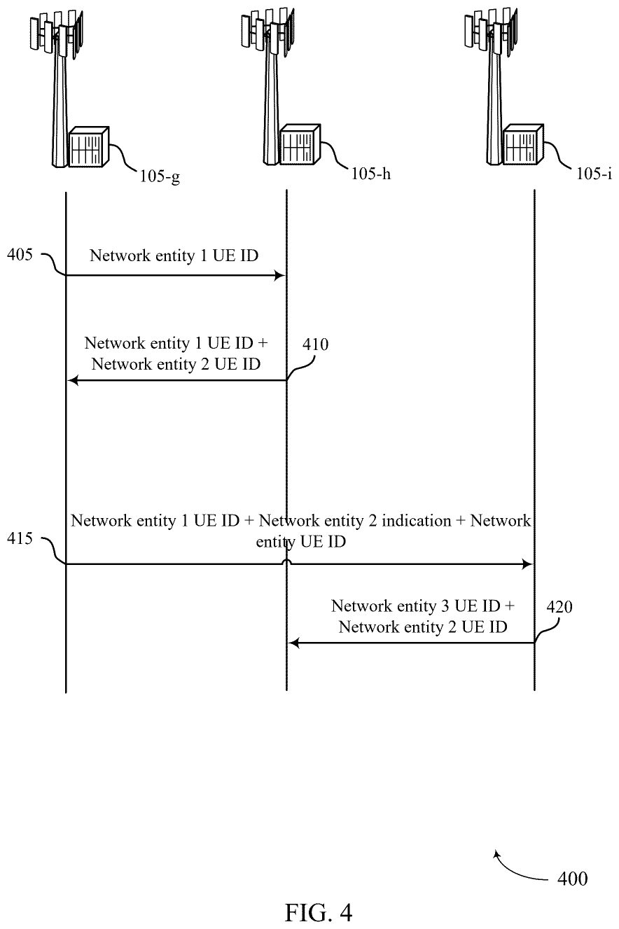

At 330, the UE 115-b may communicate with the second network entity 105-e based on the received indication to perform the cell switch operation from communicating with the first network entity 105-d to the second network entity 105-e, for example, based on using a UE ID. In some examples, and as further discussed with respect to FIGS. 4-8, the ID may include an LTM session identifier, the LTM session identifier indicating a serving network entity during an LTM preparation procedure of the LTM procedure. The identifier may include an LTM identifier coordinated between the first network entity 105-d as a serving network entity during an LTM preparation procedure of the LTM procedure and the second network entity 105-e, the third network entity 105-f, or any combination thereof, as target network entities 105. The ID may include an indication of an access and mobility management function (AMF) associated with the UE 115-b. The ID may include a TMSI provided by the UE 115-b to the first network entity 105-d. The ID may include a TMSI provided by an AMF associated with the UE 115-b to the first network entity 105-d during an LTM preparation procedure. In some examples, the first network entity 105-d may serve as a proxy between the second network entity 105-e and the third network entity 105-f (e.g., candidate network entities 105).

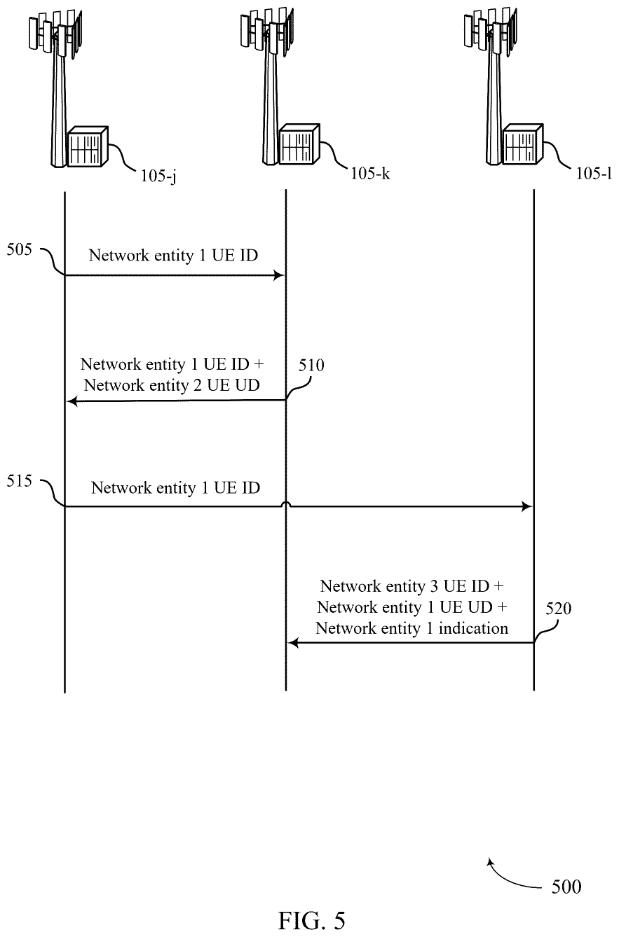

FIG. 4 shows an example of a process flow 400 that supports UE identification during a LTM session in accordance with one or more aspects of the present disclosure. The process flow 400, as well as process flows 500-800 of FIGS. 5-8, may implement aspects of or may be implemented by aspects of the wireless communications system 100 or the wireless communications system 200. For example, the process flow 400 may include a network entity 105-g, a network entity 105-h, and a network entity 105-i, which may be an example of a network entity 105 as described herein. In the following description of the process flow 400, the operations performed by the network entities 105 may be performed in different orders or at different times than the exemplary order shown. Some operations may also be omitted from the process flow 400, or other operations may be added to the process flow 400. Further, while operations in the process flow 400 are illustrated as being performed by the network entities 105, the examples herein are not to be construed as limiting, as the described features may be associated with any quantity of different device.

Process flow 400 depicts the use of XnAP IDs for identifying the UE 115 between multiple candidate network entities 105. The first network entity 105-g may assign a UE ID to the UE 115, and then inform the second network entity 105-h of the UE ID of the UE that was assigned by the first network entity 105-g. For example, at 405, the first network entity 105-g may communicate, to the second network entity 105-h, signaling indicating a first network entity UE ID, which is a UE ID assigned by the first network entity 105-g to identify the UE 115. At 410, the second network entity 105-h may communicate signaling indicating the same first network entity UE ID, along with a second network entity UE ID. The second network entity UE ID is a UE ID assigned by the second network entity 105-h for identifying the same UE 115 associated with the first network entity UE ID. That is, the second network entity 105-h may indicate that the second network entity UE ID is the respective UE ID from the second network entity 105-h and associated with the same UE 115 as the first network entity UE ID.

Accordingly, at 415, the first network entity 105-g may forward, to the third network entity 105-i, the first network entity UE ID, the second network entity UE ID allocated by second network entity 105-h, and an indication of the second network entity 105-h. A network entity indication, such as the indication of the second network entity 105-h, may refer to a network entity ID, a cell ID, a public land mobile network (PLMN) ID, or any combination thereof. By forwarding the second network entity UE ID and the indication of the second network entity 105-h to the third network entity 105-i, the third network entity 105-i may use the second network entity UE ID to identify the UE when communicating signaling regarding the particular UE 115 and/or receiving a request from the second network entity 105-h regarding the UE 115 (e.g., for handover procedure). Similarly, the third network entity 105-i may use the first network entity UE ID to reference the particular UE 115 when communicating with the first network entity 105-g.

As such, at 420, the third network entity 105-i may include the second network entity UE ID allocated by second network entity 105-h into a UE-associated signaling towards the second network entity 105-h. The signaling may also include a third network entity UE ID so that the second network entity 105-h may use the third network entity UE ID when communicating with the third network entity 105-i to reference the same UE 115 (e.g., the first network entity UE ID, the second network entity UE ID, and the third network entity UE ID all reference and are associated with the same UE). Similar signaling may be exchanged to enable the second network entity 105-h to communicate with the third network entity 105-i (e.g., the second network entity 105-h may include a third network entity UE ID allocated by third network entity 105-i into a UE-associated signaling towards the third network entity 105-i). In some examples, the network entity UE ID (e.g., the first network entity UE ID, the second network entity UE ID, and/or the third network entity UE ID) may be an XnAP ID or pair of XnAP IDs. To summarize the UE ID exchange in process flow 400, the network entities 105 exchange an ID that each network entity 105 has assigned to the same UE 115 (e.g., the first network entity 105-g assigned the first network entity UE ID to the UE 115, the second network entity 105-h assigned the second network entity UE ID to the same UE 115, and the third network entity 105-i assigned the third network entity UE ID to the same UE 115). In this manner, when an LTM procedure is triggered between any of the network entities 105, corresponding UE IDs assigned to the UE 115 by the respective network entities 105 may be included in the LTM trigger so that each of the network entities knows the same UE 115 is being referenced.

FIG. 5 shows an example of a process flow 500 that supports UE identification during a LTM session in accordance with one or more aspects of the present disclosure. Process flow 500 depicts the use of XnAP IDs for identifying the UE 115 between multiple candidate network entities 105. The first network entity 105-j (e.g., serving network entity) may assign a first network entity UE ID to the UE 115, and then inform both the second network entity 105-k and the third network entity 105-l (e.g., candidate network entities 105) of the first network entity UE ID that was assigned by the first network entity 105-j. In this manner, all the network entities 105 may use the first network entity UE ID to identify the same UE 115. Steps 505 and 510 may correspond (e.g., function similarly or provide similar information) to steps 405 and 410 of FIG. 4, respectively. For example, at 505, the first network entity 105-j may also communicate, to the second network entity 105-k, signaling indicating the first network entity UE ID, which is a UE ID assigned by the first network entity 105-j to identify the UE 115. At 510, the second network entity 105-k may also communicate signaling indicating the same first network entity UE ID, along with a second network entity UE ID. The second network entity UE ID is a UE ID assigned by the second network entity 105-k for identifying the same UE 115 associated with the first network entity UE ID. That is, the second network entity 105-k may indicate that the second network entity UE ID is the respective UE ID from the second network entity 105-k and associated with the same UE 115 as the first network entity UE ID.

At 515, the first network entity 105-j may also forward the first network entity UE ID to the third network entity 105-l (e.g., in addition to forwarding the first network entity UE ID to the second network entity 105-k). The third network entity 105-l may include the first network entity UE ID along with an indication of a first network entity ID of the first network entity 105-j into UE-associated signaling towards the second network entity 105-k. By forwarding the first network entity UE ID and to both the second network entity 105-k to the third network entity 105-l, the third network entity 105-l may use the second network entity UE ID to identify the UE when communicating signaling regarding the particular UE 115 and/or receiving a request from the second network entity 105-k regarding the UE 115 (e.g., for handover procedure).

Accordingly, at 520, the third network entity 105-l may communicate, to the second network entity 105-k, a third network entity UE ID, the first network entity UE ID, and the first network entity indication. The second network entity 105-k may use the first network entity UE ID and the first network entity ID to reference the particular UE 115 previously provided to the second network entity 105-k. The second network entity 105-k may also associated the third network entity UE ID to the same UE 115 based on also receiving the first network entity UE ID. If the second network entity 105-k communicates with the third network entity 105-l, the second network entity 105-k may also include the first network entity UE ID along with an indication of the first network entity ID of the first network entity 105-j into UE-associated signaling towards the third network entity 105-l.

The network entity indication may include a network entity ID, a cell ID, a PLMN ID, and so forth. The first network entity 105-j may additionally provide a third network entity indication to the second network entity 105-k, informing the second network entity 105-k that the third network entity 105-l may be contacted by the third network entity 105-l. The network entity UE ID (e.g., the first network entity UE ID) may be XnAP ID or pair of XnAP IDs.

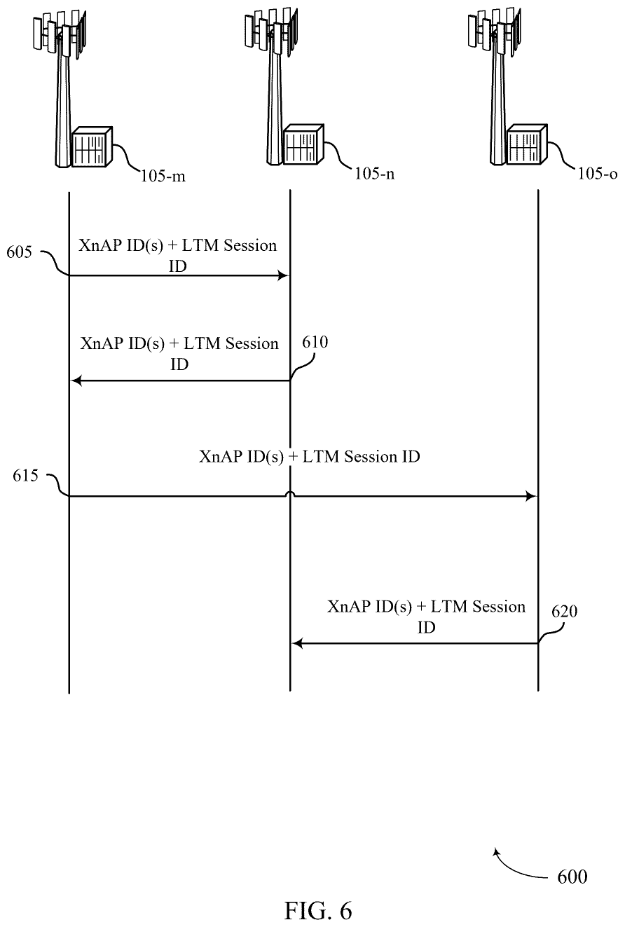

FIG. 6 shows an example of a process flow 600 that supports UE identification during a LTM session in accordance with one or more aspects of the present disclosure. Process flow 600 depicts the use of XnAP IDs for identifying the UE 115 between multiple candidate network entities 105. The first network entity 105-m (e.g., serving network entity) may inform both the second network entity 105-n and the third network entity 105-o (e.g., candidate network entities 105) of a LTM session ID that uniquely identifies the UE 115 amongst all the involved network entities 105 (e.g., serving network entity and candidate network entities). In this manner, all the network entities 105 may use the same LTM session ID to identify the same UE 115. Steps 605, 610, and 615 may correspond (e.g., operate similarly or provide similar information) to 505, 510, and 515, respectively, of FIG. 5. However, rather than network entity UE IDs as discussed with respect to FIG. 3 and FIG. 4, an LTM session ID is used to identify the physical UE 115. The LTM session ID may be unique and involved across all the network entities 105.

In some examples, the LTM session ID may include an indication of the serving network entity 105 at time of LTM preparation, where a latter network entity 105 (e.g., not the serving network entity at the time of LTM preparation) may uniquely allocate such IDs to UEs 115 configured with LTM and not have to reuse an LTM session ID until LTM configuration of the UE 115 is released. In some examples, the LTM session ID may coordinated between the serving first network entity 105-m and the candidate second network entity 105-n and candidate third network entity 105-o at LTM preparation to ensure that none of the network entities 105 are currently using the LTM session ID for some other UE 115. In another example, the LTM session ID may include an indication of the UE's AMF, where the serving first network entity 105-m at time of LTM preparation contacts the AMF and receives the LTM session ID. The network entities 105 may register LTM session ID at AMF. The serving first network entity 105-m may request the AMF to acknowledge the LTM session ID. The network entity 105 may communicate signaling between the network entities 105 to update LTM session ID across the network entities 105 (e.g., where LTM candidate cells associated with the first network entity 105-m are released).

To illustrate using the unique LTM session ID across the network entities 105 to identify the same UE 115, at 605, first network entity 105-m may communicate, to the second network entity 105-n, signaling indicating XnAP ID(s) and an LTM session ID that uniquely identifies the UE 115. Accordingly, at 610, the second network entity 105-n may communicate the XnAP IDs and the LTM session ID to the first network entity 105-m. At 615, the first network entity 105-m may also communicate the XnAP IDs and the LTM session ID to the third network entity 105-o so that the second network entity 105-n and the third network entity 105-o may commonly identify the physical UE as belonging or associated with the LTM session ID. At 620, the third network entity 105-o may transmit signaling to the second network entity 105-n, indicating the XnAP IDs and LTM session ID. The second network entity 105-n may identify the UE 115 based on the unique LTM session ID.

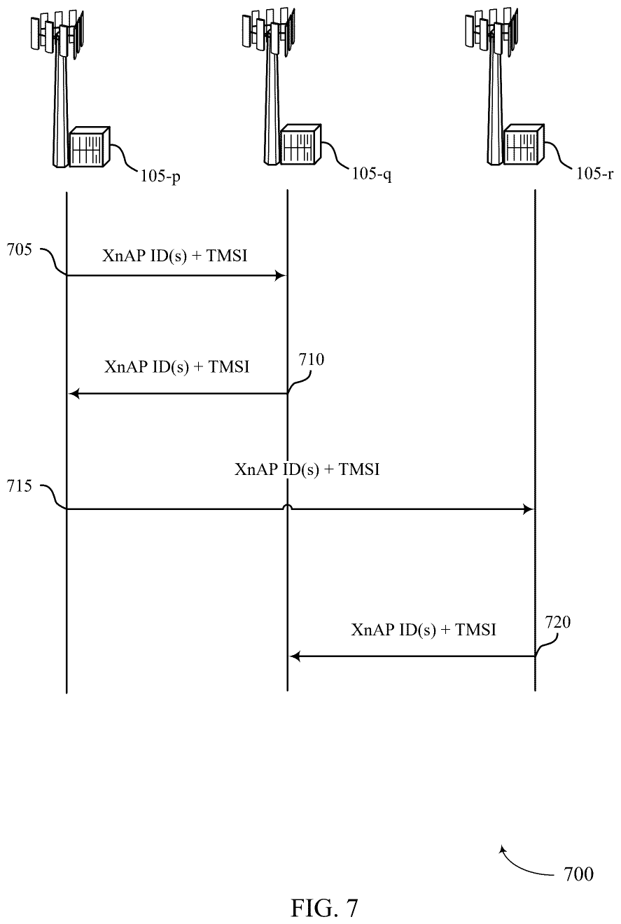

FIG. 7 shows an example of a process flow 700 that supports UE identification during a LTM session in accordance with one or more aspects of the present disclosure. Process flow 700 depicts the use of XnAP IDs for identifying the UE 115 between multiple candidate network entities 105. The first network entity 105-p (e.g., serving network entity) may inform both the second network entity 105-q and the third network entity 105-r (e.g., candidate network entities 105) of a TMSI that uniquely identifies the UE 115 amongst all the involved network entities 105 (e.g., serving network entity and candidate network entities). In this manner, all the network entities 105 may use the same TMSI identifier to identify the same UE 115. Steps 705, 710, 715, and 720 may correspond to (e.g., operate similarly or provide similar information) to 605, 610, 615, and 620, respectively, of FIG. 6. However, rather than communicating XnAP UE IDs with LTM session IDs as discussed with respect to FIG. 6, TMSIs may be used instead of the LTM session IDs.

To illustrate using the TMSI ID across the network entities 105 to identify the same UE 115, at 705, the first network entity 105-p may communicate, to the second network entity 105-q, XnAP ID(s) and a TMSI ID. At 710, the second network entity 105-q may communicate the XnAP ID(s) and the TMSI ID to the first network entity 105-p. At 715, the first network entity 105-p may communicate, to the third network entity 105-r, the XnAP IDs and the TMSI. Accordingly, both the first network entity 105-p forwarded the TMSI ID to the second network entity 105-q and the third network entity 105-r, such that the second network entity 105-q and the third network entity 105-r are aware that the particular TMSI ID is associated with the same UE 115. At 720, the third network entity 105-r may communicate, to the second network entity 105-q, the XnAP IDs with the TMSI. Since the second network entity is aware of the TSMI ID (e.g., from 705), the second network entity 105-q may identify the particular UE 115 based on the TMSI ID.

For example, the UE 115 may report a TMSI ID (or other initial UE identity) at an initial RRC setup, which may then be used for later identification of the UE 115 among the network entities 105. However, in some examples, the TMSI ID may be reconfigured by the AMF (and thus may be allocated to some other UE 115, which may result in ID collisions). Moreover, if the UE 115 accesses the serving network entity 105-p, not via initial access, the serving network entity 105-p may be unaware of the TMSI ID.

To resolve for TMSI ID being reconfigured by the AMFI or the serving network entity 105 (e.g., the serving first network entity 105-p) not knowing the TMSI, the UE 115 may report the TMSI ID to the serving network entity 105-p. The UE 115 reporting the TMSI ID to the serving network entity 105-p may include the UE 115 reporting the TMSI ID after the LTM configuration, requested by the serving first network entity 105-p, and/or reported again if the TMSI ID is reconfigured by AMF.

In some examples, to resolve for TMSI ID being reconfigured by the AMFI or the serving network entity 105 (e.g., the serving first network entity 105-p) not knowing the TMSI ID, the AMF may report the TMSI ID to the serving first network entity 105-p at LTM preparation, where reporting is per request of the serving first network entity 105-p or where the updated TMSI ID is provided by AMF to the previous or subsequent serving network entity 105. In some examples, the serving network entity 105 may send the TMSI ID update (e.g., after AMF reconfiguration) to other candidate network entity 105. In some examples, the AMF may not know the session ID or LTM and rather, the AMP may informs the network entity 105 when the UE 115 becomes idle or inactive (e.g., via network entity-AMF signaling).

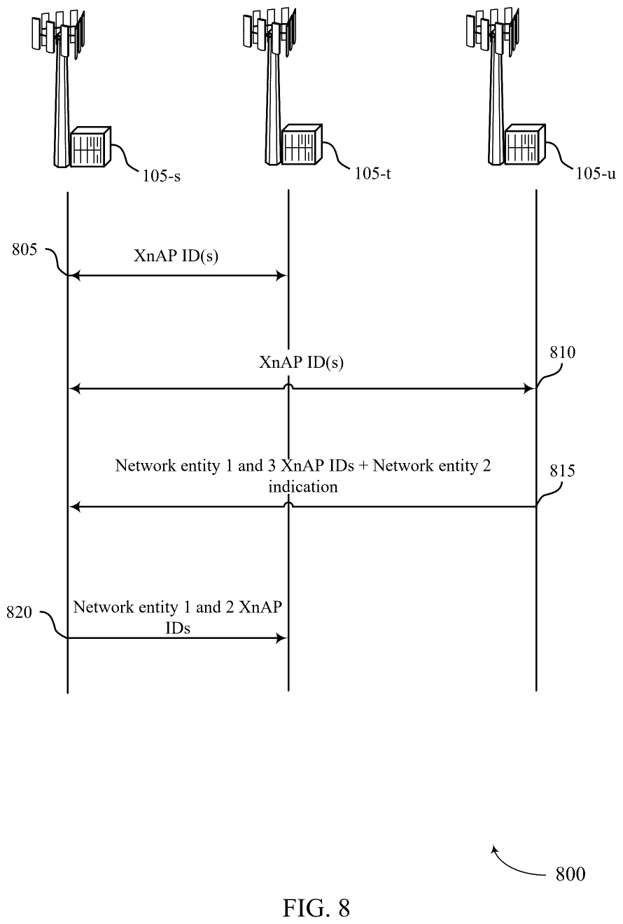

FIG. 8 shows an example of a process flow 800 that supports UE identification during a LTM session in accordance with one or more aspects of the present disclosure. Process flow 800 depicts the serving first network entity 105-s functioning as an anchor for the candidate network entities 105, such as the second network entity 105-t and the third network entity 105-u. For example, the serving first network entity 105-s may relay communications between the candidate network entities, such as the second network entity 105-t and the third network entity 105-u, using XnAP IDs.

At 805, the serving first network entity 105-s may communicate, to the second network entity 105-t, Xn signaling including XnAP ID(s), as previously discussed with respect to FIG. 6 and FIG. 7. The XnAP IDs may include IDs that identify the first network entity 105-s and the second network entity 105-t, respectively. At 810, the signaling including the XnAP ID(s) may be communicated between the first network entity 105-s, the second network entity 105-t, and/or the third network entity 105-u, such that the XnAP IDs are known between the network entities 105 for identifying respective network entities 105.

At 815, the third network entity 105-u may communicate Xn signaling including the XnAP ID(s) associated with the first network entity 105-s and the third network entity 105-u along with an indication of the second network entity 105-t (e.g., as received at 810). At 820, the first network entity 105-s may communicate signaling including the XnAP ID(s) associated with the first network entity 105-s and the second network entity 105-t. For example, the serving first network entity 105-s may initiate LTM preparation and also serve as a proxy for all candidate or target network entities 105.

In some examples, a network entity 105 that serves as a proxy for a candidate or target network entity 105, such as the first network entity 105-s serving as a proxy between the second network entity 105-t and the third network entity 105-u, may also be the network entity 105 that initiates the LTM preparation. The network entity 105 providing the proxy operation may provide the proxy operation when the network entity 105 is the serving network entity 105, such that a UE 115 is connected to the network entity 105. In some examples, the network entity 105 may provide the proxy operation when the UE 115 is connecting to a cell of another network entity 105 after an LTM execution. A previous candidate network entity 105 may send a UE-associated message to other candidate network entities 105 (e.g., subsequent or new candidates) via the serving network entity 105 that may relay the message based on the target XnAP ID of the new candidates. In some examples at 820, when the signaling from the first network entity 105-s to the second network entity 105-t includes information associated with or forwarded from the third network entity 105-u (e.g., serving as a proxy), the signaling may carry an indication of the third network entity 105-u.

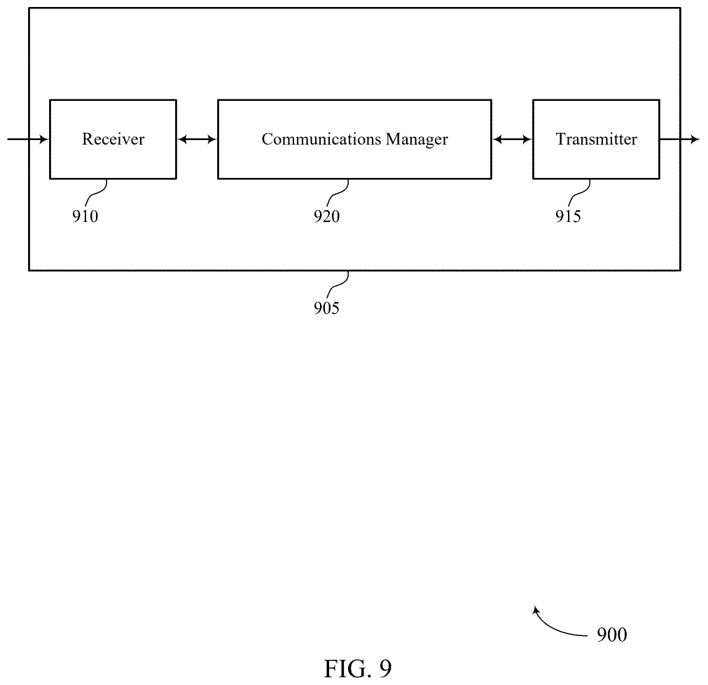

FIG. 9 shows a block diagram 900 of a device 905 that supports UE identification during a LTM session in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include one or more processors, memory coupled with the one or more processors, and instructions stored in the memory that are executable by the one or more processors to enable the one or more processors to perform the UE identification during a LTM session discussed herein. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of UE identification during a LTM session as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for communicating, with a third network entity, a first message indicating an identifier associated with a LTM procedure for a UE, the identifier for indicating that the UE is associated with the LTM procedure configured between the first network entity and a second network entity. The communications manager 920 is capable of, configured to, or operable to support a means for transmitting, to the UE, a second message indicating to perform a cell switch operation from communications with the first network entity to the second network entity or the third network entity in accordance with the LTM procedure.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reducing communication interruptions and RACH procedures that may otherwise be associated with transitioning between cells and/or network entities during a handover procedure.

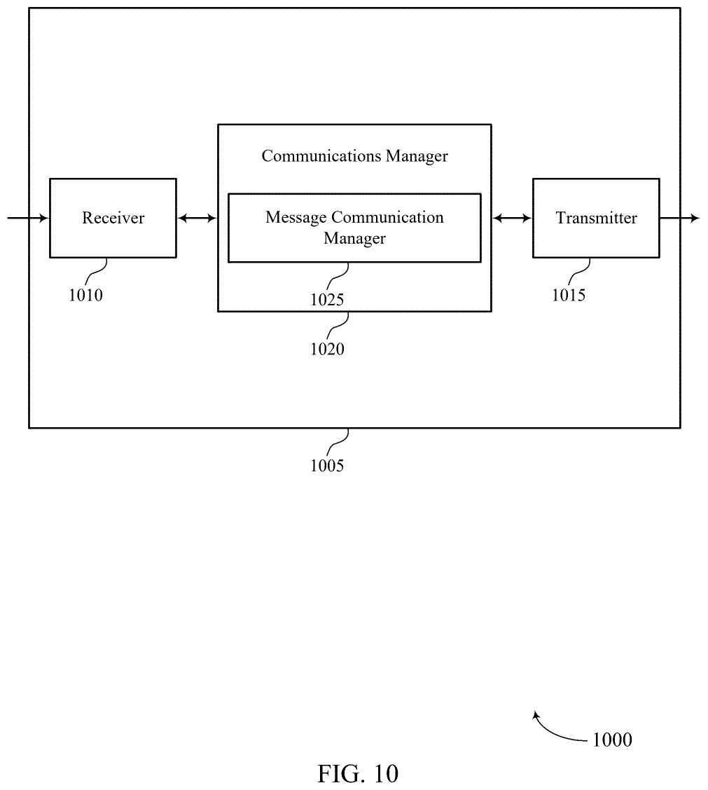

FIG. 10 shows a block diagram 1000 of a device 1005 that supports UE identification during a LTM session in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of UE identification during a LTM session as described herein. For example, the communications manager 1020 may include a message communication manager 1025, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The message communication manager 1025 is capable of, configured to, or operable to support a means for communicating, with a third network entity, a first message indicating an identifier associated with a LTM procedure for a UE, the identifier for indicating that the UE is associated with the LTM procedure configured between the first network entity and a second network entity. The message communication manager 1025 is capable of, configured to, or operable to support a means for transmitting, to the UE, a second message indicating to perform a cell switch operation from communications with the first network entity to the second network entity or the third network entity in accordance with the LTM procedure.

In some cases, the message communication manager 1025 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the message communication manager 1025 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

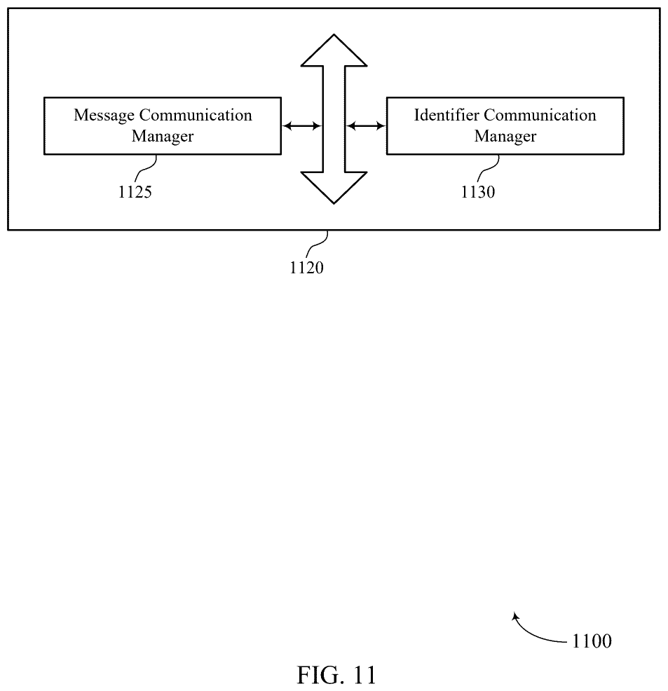

FIG. 11 shows a block diagram 1100 of a communications manager 1120 that supports UE identification during a LTM session in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of UE identification during a LTM session as described herein. For example, the communications manager 1120 may include a message communication manager 1125 an identifier communication manager 1130, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The message communication manager 1125 is capable of, configured to, or operable to support a means for communicating, with a third network entity, a first message indicating an identifier associated with a LTM procedure for a UE, the identifier for indicating that the UE is associated with the LTM procedure configured between the first network entity and a second network entity. In some examples, the message communication manager 1125 is capable of, configured to, or operable to support a means for transmitting, to the UE, a second message indicating to perform a cell switch operation from communications with the first network entity to the second network entity or the third network entity in accordance with the LTM procedure.

In some examples, the identifier includes a UE identifier allocated by the second network entity.

In some examples, the UE identifier includes a backhaul application protocol identifier.

In some examples, the identifier includes a UE identifier allocated by the first network entity, and the identifier communication manager 1130 is capable of, configured to, or operable to support a means for communicating, to the second network entity and the third network entity, the UE identifier allocated by the first network entity.

In some examples, the message communication manager 1125 is capable of, configured to, or operable to support a means for transmitting, to the second network entity, a third message indicating that the third network entity will communicate with the second network entity.

In some examples, the identifier includes an LTM session identifier, the LTM session identifier indicating a serving network entity during an LTM preparation procedure of the LTM procedure.

In some examples, the identifier includes an LTM identifier coordinated between the first network entity as a serving network entity during an LTM preparation procedure of the LTM procedure and the second network entity, the third network entity, or any combination thereof, as target network entities.

In some examples, the identifier includes an indication of an access and mobility management function associated with the UE.

In some examples, the identifier includes a TMSI provided by the UE to the first network entity.

In some examples, the identifier includes a TMSI provided by an access and mobility management function associated with the UE to the first network entity during an LTM preparation procedure.

In some examples, the first network entity serves as a proxy between the second network entity and the third network entity.

In some cases, the message communication manager 1125 and the identifier communication manager 1130 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the message communication manager 1125 and the identifier communication manager 1130 discussed herein.

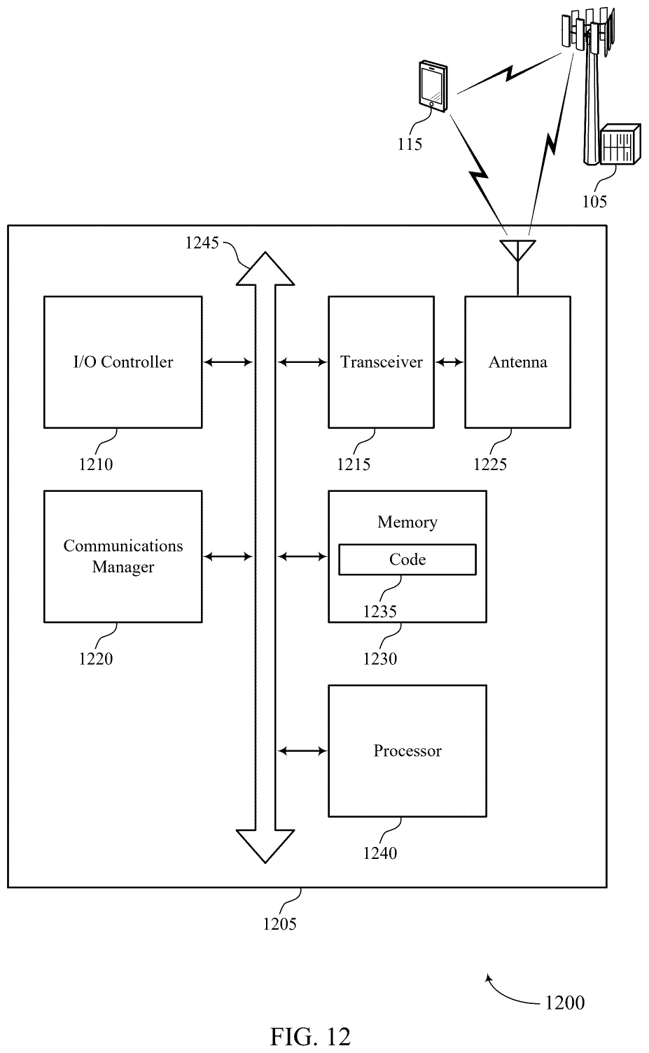

FIG. 12 shows a diagram of a system 1200 including a device 1205 that supports UE identification during a LTM session in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as an input/output controller 1210, a communications manager 1220, a transceiver 1215, one or more antennas 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The transceiver 1215 may support bi-directional communications via wired links, wireless links, or both as described herein. In some examples, the transceiver 1215 may include a wired transceiver and may communicate bi-directionally with another wired transceiver. Additionally, or alternatively, in some examples, the transceiver 1215 may include a wireless transceiver and may communicate bi-directionally with another wireless transceiver. In some examples, the device 1205 may include one or more antennas 1225, which may be capable of transmitting or receiving wireless transmissions (e.g., concurrently). The transceiver 1215 may also include a modem to modulate signals, to provide the modulated signals for transmission (e.g., by one or more antennas 1225, by a wired transmitter), to receive modulated signals (e.g., from one or more antennas 1225, from a wired receiver), and to demodulate signals. In some implementations, the transceiver 1215 may include one or more interfaces, such as one or more interfaces coupled with the one or more antennas 1225 that are configured to support various receiving or obtaining operations, or one or more interfaces coupled with the one or more antennas 1225 that are configured to support various transmitting or outputting operations, or a combination thereof. In some implementations, the transceiver 1215 may include or be configured for coupling with one or more processors or one or more memory components that are operable to perform or support operations based on received or obtained information or signals, or to generate information or other signals for transmission or other outputting, or any combination thereof. In some implementations, the transceiver 1215, or the transceiver 1215 and the one or more antennas 1225, or the transceiver 1215 and the one or more antennas 1225 and one or more processors or one or more memory components (e.g., the at least one processor 1240, the at least one memory 1230, or both), may be included in a chip or chip assembly that is installed in the device 1205. In some examples, the transceiver 1215 may be operable to support communications via one or more communications links (e.g., communication link(s) 125, backhaul communication link(s) 120, a midhaul communication link 162, a fronthaul communication link 168).

The at least one memory 1230 may include RAM, ROM, or any combination thereof. The at least one memory 1230 may store computer-readable, computer-executable, or processor-executable code, such as the code 1235. The code 1235 may include instructions that, when executed by one or more of the at least one processor 1240, cause the device 1205 to perform various functions described herein. The code 1235 may be stored in a non-transitory computer-readable medium such as system memory or another type of memory. In some cases, the code 1235 may not be directly executable by a processor of the at least one processor 1240 but may cause a computer (e.g., when compiled and executed) to perform functions described herein. In some cases, the at least one memory 1230 may include, among other things, a BIOS which may control basic hardware or software operation such as the interaction with peripheral components or devices. In some examples, the at least one processor 1240 may include multiple processors and the at least one memory 1230 may include multiple memories. One or more of the multiple processors may be coupled with one or more of the multiple memories which may, individually or collectively, be configured to perform various functions herein (for example, as part of a processing system).

The at least one processor 1240 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into one or more of the at least one processor 1240. The at least one processor 1240 may be configured to execute computer-readable instructions stored in a memory (e.g., one or more of the at least one memory 1230) to cause the device 1205 to perform various functions (e.g., functions or tasks supporting UE identification during a LTM session). For example, the device 1205 or a component of the device 1205 may include at least one processor 1240 and at least one memory 1230 coupled with one or more of the at least one processor 1240, the at least one processor 1240 and the at least one memory 1230 configured to perform various functions described herein. The at least one processor 1240 may be an example of a cloud-computing platform (e.g., one or more physical nodes and supporting software such as operating systems, virtual machines, or container instances) that may host the functions (e.g., by executing code 1235) to perform the functions of the device 1205. The at least one processor 1240 may be any one or more suitable processors capable of executing scripts or instructions of one or more software programs stored in the device 1205 (such as within one or more of the at least one memory 1230).

In some examples, the at least one processor 1240 may include multiple processors and the at least one memory 1230 may include multiple memories. One or more of the multiple processors may be coupled with one or more of the multiple memories, which may, individually or collectively, be configured to perform various functions herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs via the input/output controller 1210 to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1230 or otherwise, to perform one or more of the functions described herein.

In some examples, a bus 1245 may support communications of (e.g., within) a protocol layer of a protocol stack. In some examples, a bus 1245 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1215, the at least one memory 1230, the code 1235, and the at least one processor 1240 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for communicating, with a third network entity, a first message indicating an identifier associated with a LTM procedure for a UE, the identifier for indicating that the UE is associated with the LTM procedure configured between the first network entity and a second network entity. The communications manager 1220 is capable of, configured to, or operable to support a means for transmitting, to the UE, a second message indicating to perform a cell switch operation from communications with the first network entity to the second network entity or the third network entity in accordance with the LTM procedure.

By including or configuring the communications manager 1220 in accordance with examples as described herein, the device 1205 may support techniques for reducing communication interruptions and RACH procedures that may otherwise be associated with transitioning between cells and/or network entities 105 during a handover procedure.

In some examples, the communications manager 1220 may be configured to perform various operations (e.g., receiving, obtaining, monitoring, outputting, transmitting) using or otherwise in cooperation with the transceiver 1215, the one or more antennas 1225 (e.g., where applicable), or any combination thereof. Although the communications manager 1220 is illustrated as a separate component, in some examples, one or more functions described with reference to the communications manager 1220 may be supported by or performed by the transceiver 1215, one or more of the at least one processor 1240, one or more of the at least one memory 1230, the code 1235, or any combination thereof (for example, by a processing system including at least a portion of the at least one processor 1240, the at least one memory 1230, the code 1235, or any combination thereof). For example, the code 1235 may include instructions executable by one or more of the at least one processor 1240 to cause the device 1205 to perform various aspects of UE identification during a LTM session as described herein, or the at least one processor 1240 and the at least one memory 1230 may be otherwise configured to, individually or collectively, perform or support such operations.

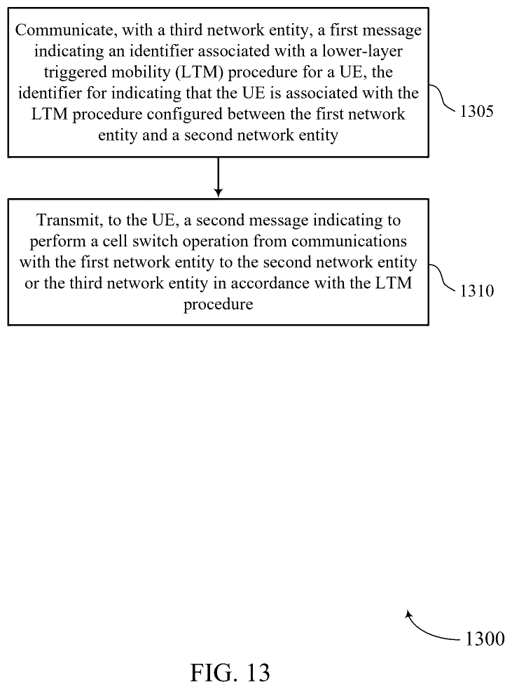

FIG. 13 shows a flowchart illustrating a method 1300 that supports UE identification during a LTM session in accordance with one or more aspects of the present disclosure. The operations of the method 1300 may be implemented by a network entity or its components as described herein. For example, the operations of the method 1300 may be performed by a network entity as described with reference to FIGS. 1 through 12. In some examples, a network entity may execute a set of instructions to control the functional elements of the network entity to perform the described functions. Additionally, or alternatively, the network entity may perform aspects of the described functions using special-purpose hardware.

At 1305, the method may include communicating, with a third network entity, a first message indicating an identifier associated with a LTM procedure for a UE, the identifier for indicating that the UE is associated with the LTM procedure configured between the first network entity and a second network entity. The operations of 1305 may be performed in accordance with examples as disclosed herein. In some examples, aspects of the operations of 1305 may be performed by a message communication manager 1125 as described with reference to FIG. 11.

At 1310, the method may include transmitting, to the UE, a second message indicating to perform a cell switch operation from communications with the first network entity to the second network entity or the third network entity in accordance with the LTM procedure. The operations of 1310 may be performed in accordance with examples as disclosed herein. In some examples, aspects of the operations of 1310 may be performed by a message communication manager 1125 as described with reference to FIG. 11.

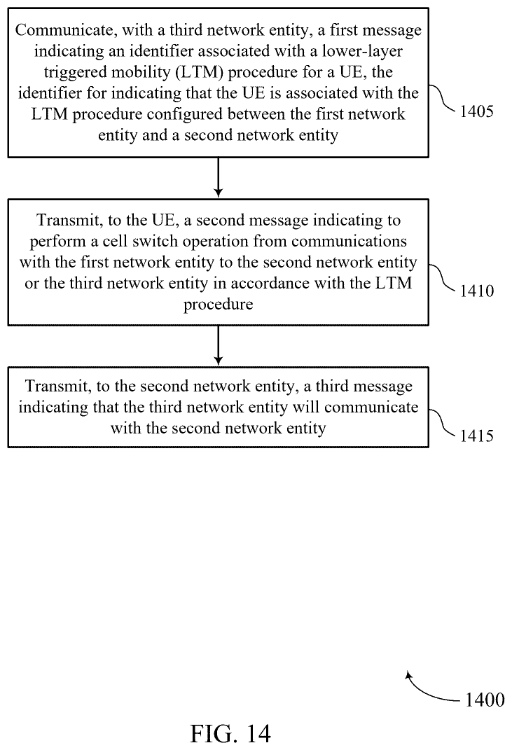

FIG. 14 shows a flowchart illustrating a method 1400 that supports UE identification during a LTM session in accordance with one or more aspects of the present disclosure. The operations of the method 1400 may be implemented by a network entity or its components as described herein. For example, the operations of the method 1400 may be performed by a network entity as described with reference to FIGS. 1 through 12. In some examples, a network entity may execute a set of instructions to control the functional elements of the network entity to perform the described functions. Additionally, or alternatively, the network entity may perform aspects of the described functions using special-purpose hardware.

At 1405, the method may include communicating, with a third network entity, a first message indicating an identifier associated with a LTM procedure for a UE, the identifier for indicating that the UE is associated with the LTM procedure configured between the first network entity and a second network entity. The operations of 1405 may be performed in accordance with examples as disclosed herein. In some examples, aspects of the operations of 1405 may be performed by a message communication manager 1125 as described with reference to FIG. 11.

At 1410, the method may include transmitting, to the UE, a second message indicating to perform a cell switch operation from communications with the first network entity to the second network entity or the third network entity in accordance with the LTM procedure. The operations of 1410 may be performed in accordance with examples as disclosed herein. In some examples, aspects of the operations of 1410 may be performed by a message communication manager 1125 as described with reference to FIG. 11.

At 1415, the method may include transmitting, to the second network entity, a third message indicating that the third network entity will communicate with the second network entity. The operations of 1415 may be performed in accordance with examples as disclosed herein. In some examples, aspects of the operations of 1415 may be performed by a message communication manager 1125 as described with reference to FIG. 11.

The following provides an overview of aspects of the present disclosure:

Aspect 1: A method for wireless communications at first network entity, comprising: communicating, with a third network entity, a first message indicating an identifier associated with an LTM procedure for a UE, the identifier for indicating that the UE is associated with the LTM procedure configured between the first network entity and a second network entity; and transmitting, to the UE, a second message indicating to perform a cell switch operation from communications with the first network entity to the second network entity or the third network entity in accordance with the LTM procedure.

Aspect 2: The method of aspect 1, wherein the identifier comprises a UE identifier allocated by the second network entity.

Aspect 3: The method of aspect 2, wherein the UE identifier comprises a backhaul application protocol identifier.

Aspect 4: The method of any of aspects 1 through 3, wherein the identifier comprises a UE identifier allocated by the first network entity, and wherein the method further comprises: communicating, to the second network entity and the third network entity, the UE identifier allocated by the first network entity.

Aspect 5: The method of aspect 4, further comprising: transmitting, to the second network entity, a third message indicating that the third network entity will communicate with the second network entity.

Aspect 6: The method of any of aspects 1 through 5, wherein the identifier comprises an LTM session identifier, the LTM session identifier indicating a serving network entity during an LTM preparation procedure of the LTM procedure.

Aspect 7: The method of any of aspects 1 through 6, wherein the identifier comprises an LTM identifier coordinated between the first network entity as a serving network entity during an LTM preparation procedure of the LTM procedure and the second network entity, the third network entity, or any combination thereof, as target network entities.

Aspect 8: The method of any of aspects 1 through 7, wherein the identifier comprises an indication of an access and mobility management function associated with the UE.

Aspect 9: The method of any of aspects 1 through 8, wherein the identifier comprises a TMSI provided by the UE to the first network entity.

Aspect 10: The method of any of aspects 1 through 9, wherein the identifier comprises a TMSI provided by an access and mobility management function associated with the UE to the first network entity during an LTM preparation procedure.

Aspect 11: The method of any of aspects 1 through 10, wherein the first network entity serves as a proxy between the second network entity and the third network entity.

Aspect 12: A first network entity for wireless communications, comprising one or more memories storing processor-executable code, and one or more processors coupled with the one or more memories and individually or collectively operable to execute the code to cause the first network entity to perform a method of any of aspects 1 through 11.

Aspect 13: A first network entity for wireless communications, comprising at least one means for performing a method of any of aspects 1 through 11.

Aspect 14: A non-transitory computer-readable medium storing code for wireless communications, the code comprising instructions executable by one or more processors to perform a method of any of aspects 1 through 11.

It should be noted that the methods described herein describe possible implementations. The operations and the steps may be rearranged or otherwise modified and other implementations are possible. Further, aspects from two or more of the methods may be combined.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network entity, comprising:
one or more memories storing processor-executable code; and
one or more processors coupled with the one or more memories, wherein the one or more processors are individually or collectively configured to cause the first network entity to:
communicate, with a third network entity, a first message indicating an identifier associated with a lower-layer triggered mobility (LTM) procedure for a user equipment (UE), the identifier for indicating that the UE is associated with the LTM procedure configured between the first network entity and a second network entity; and
transmit, to the UE, a second message indicating to perform a cell switch operation from communications with the first network entity to the second network entity or the third network entity in accordance with the LTM procedure.

2. The first network entity of claim 1, wherein the identifier comprises a UE identifier allocated by the second network entity.

3. The first network entity of claim 2, wherein the UE identifier comprises a backhaul application protocol identifier.

4. The first network entity of claim 1, wherein the identifier comprises a UE identifier allocated by the first network entity, and wherein the one or more processors are individually or collectively configured to cause the first network entity to:
communicate, to the second network entity and the third network entity, the UE identifier allocated by the first network entity.

5. The first network entity of claim 4, wherein the one or more processors are individually or collectively configured to cause the first network entity to:
transmit, to the second network entity, a third message indicating that the third network entity will communicate with the second network entity.

6. The first network entity of claim 1, wherein the identifier comprises an LTM session identifier, the LTM session identifier indicating a serving network entity during an LTM preparation procedure of the LTM procedure.

7. The first network entity of claim 1, wherein the identifier comprises an LTM identifier coordinated between the first network entity as a serving network entity during an LTM preparation procedure of the LTM procedure and the second network entity, the third network entity, or any combination thereof, as target network entities.

8. The first network entity of claim 1, wherein the identifier comprises an indication of an access and mobility management function associated with the UE.

9. The first network entity of claim 1, wherein the identifier comprises a temporary mobile subscriber identity (TMSI) provided by the UE to the first network entity.

10. The first network entity of claim 1, wherein the identifier comprises a temporary mobile subscriber identity (TMSI) provided by an access and mobility management function associated with the UE to the first network entity during an LTM preparation procedure.

11. The first network entity of claim 1, wherein the first network entity serves as a proxy between the second network entity and the third network entity.

12. A method for wireless communications at first network entity, comprising:
communicating, with a third network entity, a first message indicating an identifier associated with a lower-layer triggered mobility (LTM) procedure for a user equipment (UE), the identifier for indicating that the UE is associated with the LTM procedure configured between the first network entity and a second network entity; and
transmitting, to the UE, a second message indicating to perform a cell switch operation from communications with the first network entity to the second network entity or the third network entity in accordance with the LTM procedure.

13. The method of claim 12, wherein the identifier comprises a UE identifier allocated by the second network entity.

14. The method of claim 13, wherein the UE identifier comprises a backhaul application protocol identifier.

15. The method of claim 12, wherein the identifier comprises a UE identifier allocated by the first network entity, and wherein the method further comprises:
communicating, to the second network entity and the third network entity, the UE identifier allocated by the first network entity.

16. The method of claim 15, further comprising:
transmitting, to the second network entity, a third message indicating that the third network entity will communicate with the second network entity.

17. The method of claim 12, wherein the identifier comprises an LTM session identifier, the LTM session identifier indicating a serving network entity during an LTM preparation procedure of the LTM procedure.

18. The method of claim 12, wherein the identifier comprises an LTM identifier coordinated between the first network entity as a serving network entity during an LTM preparation procedure of the LTM procedure and the second network entity, the third network entity, or any combination thereof, as target network entities.

19. A non-transitory computer-readable medium storing code for wireless communications, the code comprising instructions executable by one or more processors to:
communicate, with a third network entity, a first message indicating an identifier associated with a lower-layer triggered mobility (LTM) procedure for a user equipment (UE), the identifier for indicating that the UE is associated with the LTM procedure configured between a first network entity and a second network entity; and
transmit, to the UE, a second message indicating to perform a cell switch operation from communications with the first network entity to the second network entity or the third network entity in accordance with the LTM procedure.

20. The non-transitory computer-readable medium of claim 19, wherein the first network entity serves as a proxy between the second network entity and the third network entity.
